(19) United States
(12) Patent Application Publication
(10) Pub. No.: US 2026/0268765 A1
(43) Pub. Date: Sep. 10, 2026

(54) METHOD AND APPARATUS TO REDUCE TRAFFIC ACCIDENTS AT TRAFFIC LIGHTS BY DISPLAYING A TIMER COUNTDOWN OF WHEN THE LIGHT WILL CHANGE ie TRAFFIC LIGHT TIMER

(71) Applicant: Joel Saliman, Avondale, AZ (US)

(72) Inventor: Joel Saliman, Avondale, AZ (US)

(21) Appl. No.: 19/071,711

(22) Filed: Mar. 5, 2025

(51) Int. Cl. G08G 1/096

(52) U.S. Cl. CPC G08G 1/096

(57) ABSTRACT

The Traffic Light Timer will help save lives and reduce accidents at red lights by informing drivers when exactly the light will change so they can make informed decisions. The Traffic Light Timer as an add-on the existing traffic lights will take existing information and power from the traffic light controller already imbedded into the traffic light. The Traffic Light Timer as a licensed add on to new traffic lights will take existing information and power from the traffic light controller already imbedded into the traffic light.

To All Whom it May Concern

Be it known that I Joel Saliman a citizen of the United States of America residing at 3126 N 129^{th} dr Avondale AZ 85392 in the state of Arizona has invented a new, original utility patent. Of which the following is a specification reference being had to the accompanying drawing format part thereof:

TRAFFIC LIGHT TIMER either as an add on or incorporated into a new traffic light design by way of licensing the device to inform drivers when the light will change so they know if it's safe to continue or to get ready to stop before being surprised with a yellow then red light.

It is a box that will be about 15 inches wide and about 30 inches tall containing BI-Color LED lights that will receive a signal from the existing traffic timer that's in the control box of the traffic lights and will start to count down at 30 seconds. The number counting down will be green for green lights and red for red lights. It'll also be licensed to existing traffic light builders as a standard safety option.

The system is simple. It is a display of the countdown for when the light will change from green to red and from red to green. As you're probably aware driving as you see a green light, you may speed up maybe a little to try to get the green light and sometimes, you're so close that it's either slam on the brakes and possibly slide into the intersection or punch it and go faster so that you beat the red lights. Either one of these presents a dangerous situation.

If you know when the light is going to go from green to red and you're too far away then obviously, start slowing down and prepare to stop. If you're right up on it then you can speed up a little bit and go through it.

The reason why you'd want to show a timer from going from red to green is you're sitting there waiting, wondering what the heck is going on. Is this light ever going to change. As the saying goes knowledge is power. It'll also prevent people from being on their phone or doing other things while waiting for a long red light and holding up traffic.

According to the Federal Highway Administration, one-quarter of all traffic fatalities and one-half of all traffic injuries happen at intersections.

In the United States, there are hundreds of thousands of crashes at traffic lights each year, including many that are caused by red-light running.

Red-light running crashes: in 2022, 1,149 people were killed in crashes involving red-light running.

Total intersection accidents: The Federal Highway Administration (FHA) estimates that there are about 2.5 million intersection accidents each year.

Fatalities at signalized intersections: There are an average of 7 fatal crashes and over 1,000 injury crashes every day at signalized

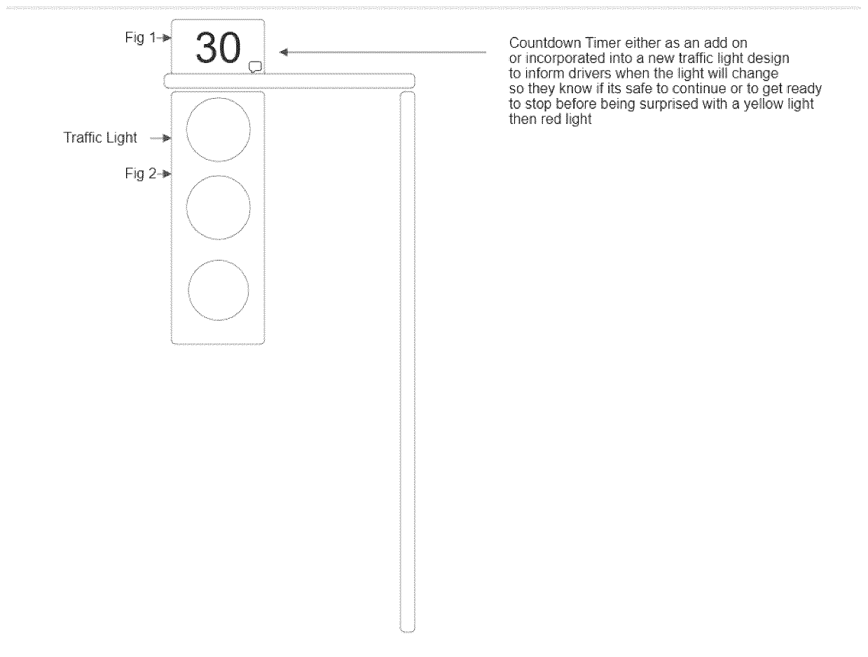

FIG. 1 Is a front view of a traffic light with the traffic light timer attached to the top.

The utility design is for a traffic light timer.

1. What is claimed is by installing the Traffic Light Timer on an existing traffic light it will reduce the number of red-light runners, accidents and deaths at intersections because the driver is now informed of the time when the light will change and can make an informed decision about the driving.

2. By having the Traffic Light Timer showing the red light counted down will inform drivers how long they have to wait at a light so it will help with the flow of traffic instead of having to wait for someone who is distracted.

3. By licensing the Traffic Light Timer to be incorporated into new traffic lights it will reduce the number of red-light runners and accidents and deaths at intersections because the driver is now informed of the time when the light will change.
